(19) United States
(12) Patent Application Publication
(10) Pub. No.: US 2016/0216829 A1
(43) Pub. Date: Jul. 28, 2016

(54) Method for Making External Input Devices to Function as Touch Control to Handheld Computer

(71) Applicants: Kun-Yuan Lin, Taipei City (TW); Chung-Han Hsieh, Taipei City (TW)

(72) Inventors: Kun-Yuan Lin, Taipei City (TW); Chung-Han Hsieh, Taipei City (TW)

(73) Assignee: I/O INTERCONNECT, LTD., Santa Ana, CA (US)

(21) Appl. No.: 14/973,798

(22) Filed: Dec. 18, 2015

Related U.S. Application Data
(63) Continuation-in-part of application No. 14/607,046, filed on Jan. 27, 2015.

(51) Int. Cl. G06F 3/041; G06F 3/14; G06F 3/0481; G06F 3/0488; G06F 3/0354; G06F 3/038

(52) U.S. Cl. CPC G06F 3/0416; G06F 3/03543; G06F 3/03547; G06F 3/038; G06F 3/0412; G06F 3/04812; G06F 3/04886; G06F 3/1423

(57) ABSTRACT

A method for making input devices connected to a smartphone to function as touch control to the smartphone is disclosed. The method includes the steps of: a) operatably connecting the handheld computer to a personal computer with an input device; b) presenting the input device to be a virtual touch sensitive device to the handheld computer when the input device is a non-touch sensitive device; c) converting a first touch event of the input device into a second touch event compatible to the handheld computer when the input device is a touch sensitive device and is being touched; and d) sending the second touch event to the handheld computer.

### CROSS-REFERENCE TO RELATED APPLICATIONS

This application is a continuation-in-part of U.S. patent application Ser. No. 14/607,046, filed Jan. 27, 2015, now pending.

### BACKGROUND OF THE INVENTION

1. Technical Field

The invention relates to handheld computers such as smartphones and tablet computers, particularly in situations when a handheld computer is connected to external input devices such as a touchscreen display, a touchpad or a mouse.

2. Related Art

Handheld computers, such as smartphones and tablets, have become essential for most people. Some users of handheld computers have the need to connect their handheld computers to a personal computer that has one or more input devices such as a touchscreen monitor, a touchpad or a mouse. Some software applications can allow users to operate the handheld computer via the mouse on personal computer that has been connected to the handheld computer. However, there is no solution which can integrate other types of input devices to operate a handheld computer, especially with touch sensitive input devices because their touch control systems are not integrated with that of the handheld computer. This is very inconvenient for those users who can already connect their handheld computers to an external personal computer.

### SUMMARY OF THE INVENTION

An object of the invention is to provide a method for making external input devices to function as touch control to a handheld computer, which allows users to operate a handheld computer by operating any one of the external input devices.

To accomplish the above said object, the method for making external input devices into a touch control to a handheld computer of the invention includes the steps of:

a) operatably connecting the handheld computer to a personal computer with an input device;

b) presenting the input device as a virtual touch sensitive device to the handheld computer when the input device is a non-touch sensitive device;

c) converting a first touch event of the input device into a second touch event compatible to the handheld computer when the input device is a touch sensitive device and is being touched; and

d) sending the second touch event to the handheld computer.

### BRIEF DESCRIPTION OF THE DRAWINGS

FIG. 1 is a schematic view of hardware arrangement of the invention;

FIG. 2 is another schematic view of hardware arrangement of the invention;

FIG. 3 is still another schematic view of hardware arrangement of the invention;

FIG. 4 is yet another schematic view of hardware arrangement of the invention; and

FIG. 5 is a flowchart of the method of the invention.

### DETAILED DESCRIPTION OF THE INVENTION

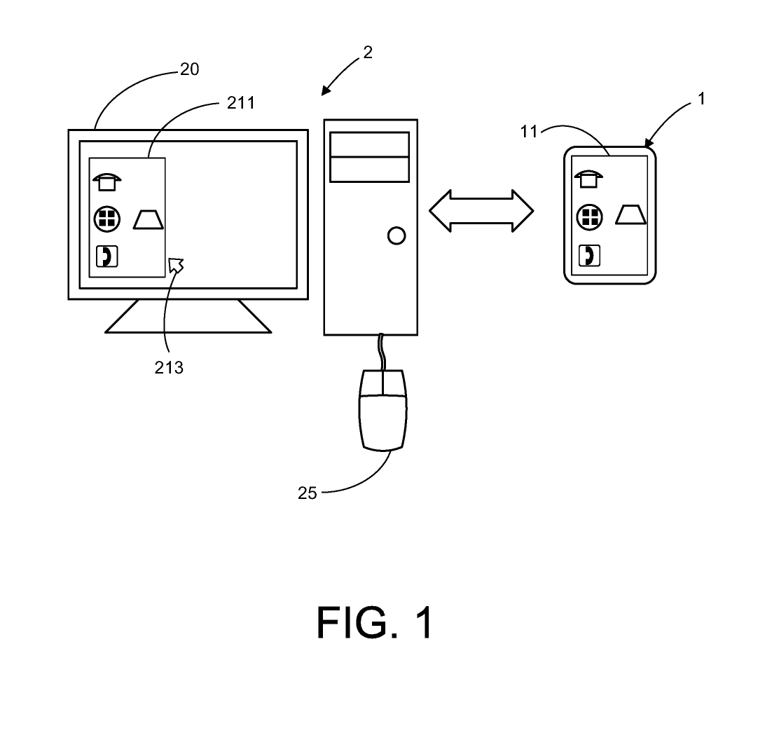

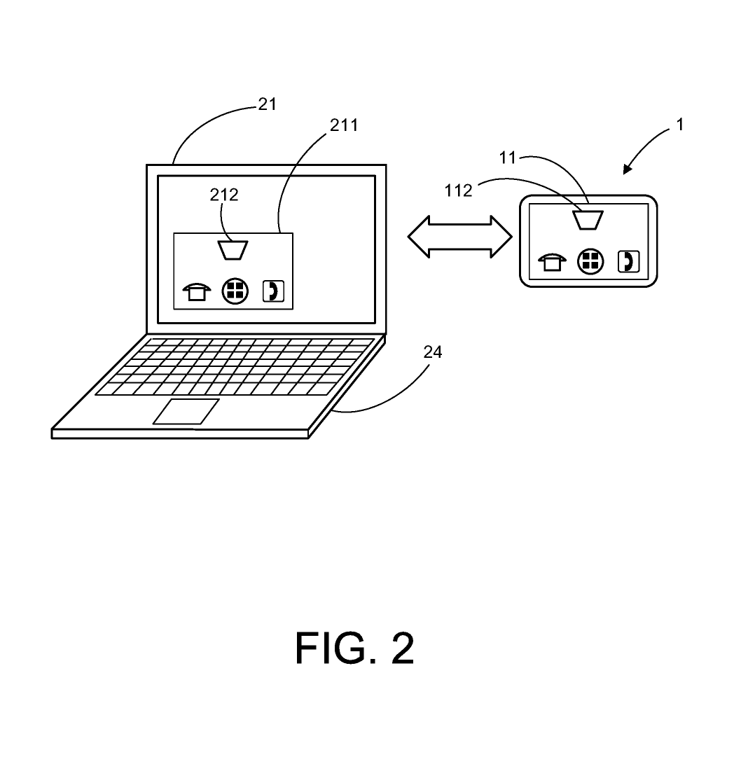

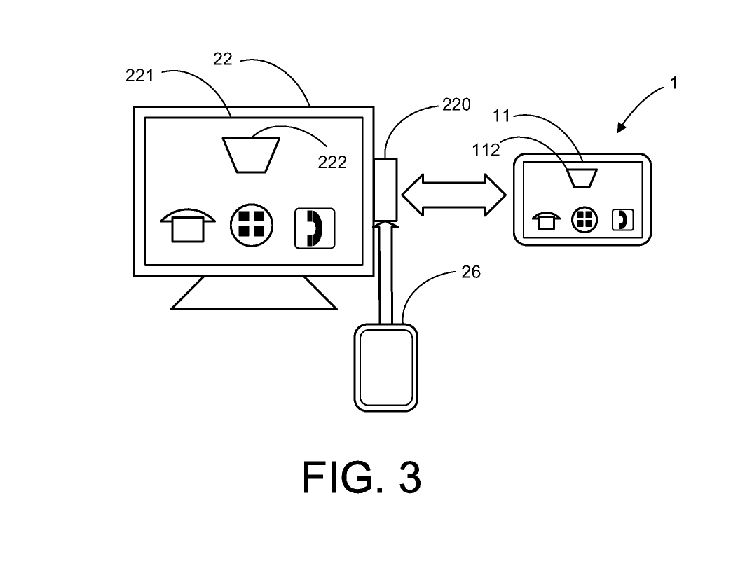

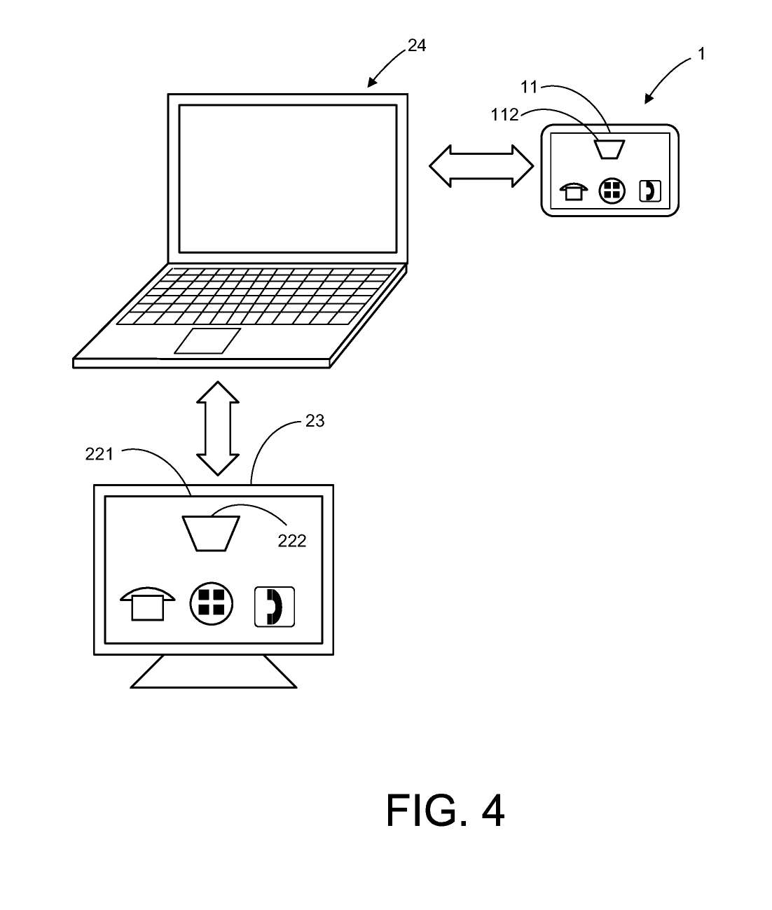

Please refer to FIG. 1. The invention provides a method for making input devices of a personal computer 2 functioning as touch control to a handheld computer 1. The handheld computer 1 may be a smartphone or a tablet computer. Also the handheld computer 1 must be provided with a touchscreen display 11. The input devices can be categorized into a touch sensitive type such as a touchscreen display 20 and a non-touch sensitive type such as a mouse 25. In this scenario, there must be a cursor 213 shown on the touchscreen display 20. In other scenarios, the touch sensitive input device may be implemented by various modes. For example, it may be a touchscreen monitor 21 of a laptop computer 24 as shown in FIG. 2, an individual touchscreen monitor 22 with an embedded system 220 as shown in FIG. 3 or an external touchscreen monitor 23 connected to a laptop computer 24 as shown in FIG. 4. In the arrangement shown in FIG. 3, the embedded system 220 functions as an interface controller between the handheld computer 1 and the individual touchscreen monitor 22. A touchpad 26, which may be of a touch sensitive type functioning as a touchscreen or of a non-touch sensitive type functioning as a mouse, can also be used as the input device as shown in FIG. 3. In the arrangement shown in FIG. 4, the connection between the external touchscreen monitor 23 and the laptop computer 24 requires a USB (universal serial bus) cable for control signal transmission and a VGA (Video Graphics Array) cable or an HDMI (High Definition Multimedia Interface) cable for video signal transmission.

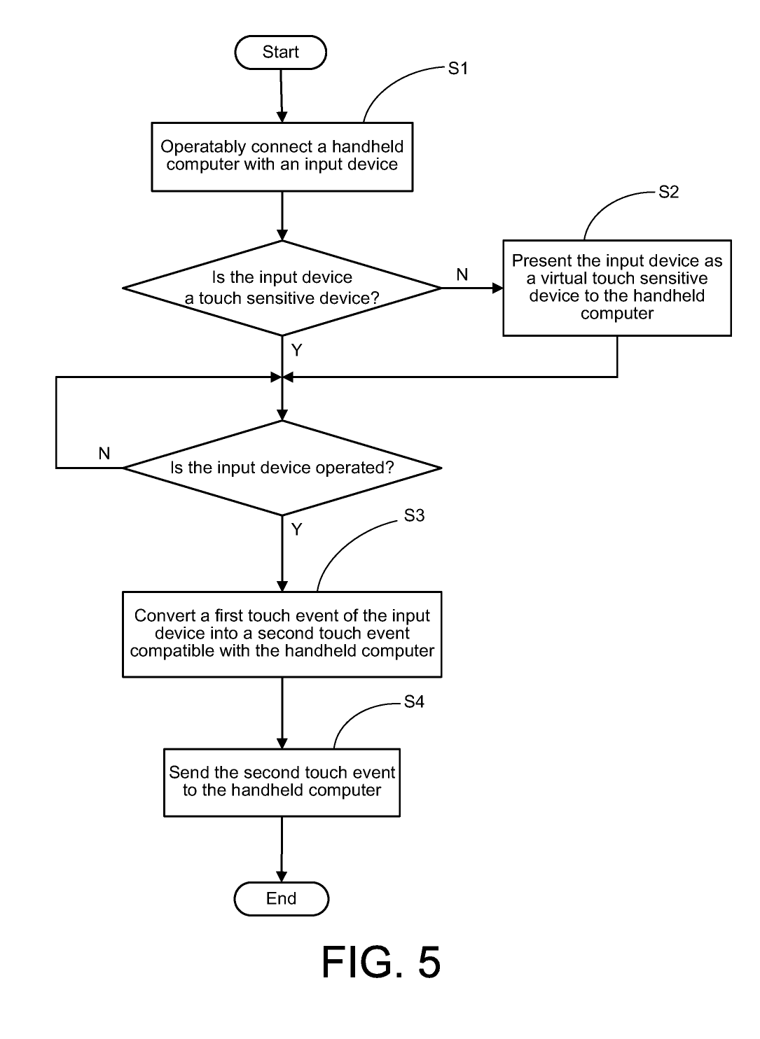

Please refer to FIG. 5, which shows a flowchart of the method of the invention. In step S1, the handheld computer 1 is operatably connected to the input device through a personal computer 2 or 24 or an embedded system 220. The connection between the handheld computer 1 and the personal computer 2 or 24 or the embedded system 220 may be implemented by a USB (universal serial bus) cable. In detail, an AOA (Android Open Accessory) protocol is performed between the handheld computer 1 and the personal computer 2 or 24 or the embedded system 220 through the USB cable. A screen picture of the handheld computer 1 is projected on the touchscreen display 20, touchscreen monitor 21 of a laptop computer 24, or an external touchscreen monitor 23 connected to a laptop computer 24 as a subwindow 211 as shown in FIGS. 1 and 2. A screen picture of the handheld computer 1 is projected on an individual touchscreen monitor 22 with an embedded system 220 or an external touchscreen monitor 23 connected to a laptop computer 24 as a full window 221 as shown in FIGS. 3 and 4. In detail, in the arrangements shown in FIGS. 3 and 4, the full window 221 will include two blank sidebars when the handheld computer 1 is kept upright. The personal computer 2 or laptop computer 24 still keeps working independently. Of course, all contents including items, pictures and their relative position of the subwindow 211 or full window 221 are the same as the handheld computer 1.

In step S2, the input device is presented as a virtual touch sensitive device to the handheld computer 1 when the input device is a non-touch sensitive device such as a mouse 25.

In step S3, when the input device is a touch sensitive device or the step S2 has been performed, a first touch event of the input device is converted into a second touch event compatible with the handheld computer 1 if the input device is being operated in the full window 221 or the subwindow 211. In detailed, when a first item 212 or 222 in the subwindow 211 or full window 221 is being touched or clicked by a user, a first touch event to the first item 212 or 222 will be converted into a second touch event to a second item 112 of the handheld computer 1, in which the second item 112 in the first touchscreen display 11 corresponds to or is equivalent to the first item 212 or 222 in the subwindow 211 or full window 221. In other words, a virtual touch to the second item 112 is generated when the first item 212 or 222 is being touched or clicked. In detail, the first touch event and the second touch event may be a Windows touch event and an Android touch event, respectively.

Finally, in step S4, the second touch event is sent to the handheld computer 1 so that a virtually corresponding touch to the second item 112 of the handheld computer 1 can be generated. That is, the handheld computer 1 can be synchronously operated with the input device.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for making an external touchscreen display to function as touch control to a handheld computer also with a touchscreen display, comprising the steps of:
a) operatably connecting the handheld computer to a personal computer with the external touchscreen display or an embedded system coupled to the external touchscreen display;
b) converting a first touch event of the external touchscreen display into a second touch event compatible with the handheld computer when the external touchscreen display is being touched; and
c) sending the second touch event to the handheld computer.

2. The method of claim 1, wherein the handheld computer is a smartphone or a tablet computer.

3. The method of claim 1, wherein a connection between the handheld computer and the personal computer or the embedded system is a wired link.

4. The method of claim 3, wherein the wired link is a USB (universal serial bus) cable.

5. The method of claim 4, wherein an AOA (Android Open Accessory) protocol is performed between the handheld computer and the personal computer through the USB cable.

6. The method of claim 1, wherein the external touchscreen display is a monitor of a laptop computer.

7. The method of claim 1, wherein the external touchscreen display is an individual monitor.

8. The method of claim 1, wherein the external touchscreen display is an external touchscreen monitor connected to a laptop computer.

9. The method of claim 1, wherein the first touch event and the second touch event are a Windows touch event and an Android touch event, respectively.

10. The method of claim 1, further comprising a touchpad connected to the personal computer or the embedded system to serve as a touch sensitive input device.

11. A method for making a cursor control device to function as touch control to a handheld computer with a touchscreen display, comprising the steps of:
a) operatably connecting the handheld computer to the cursor control device through a personal computer;
b) presenting the cursor control device as a virtual touch sensitive device to the handheld computer;
c) converting a first touch event of the virtual touch sensitive device into a second touch event compatible with the handheld computer when the cursor control device is being operated; and
d) sending the second touch event to the handheld computer.

12. The method of claim 11, wherein the handheld computer is a smartphone or a tablet computer.

13. The method of claim 11, wherein a connection between the handheld computer and the personal computer is a wired link.

14. The method of claim 13, wherein the wired link is a USB (universal serial bus) cable.

15. The method of claim 14, wherein an AOA (Android Open Accessory) protocol is performed between the handheld computer and the personal computer through the USB cable.

16. The method of claim 11, wherein the cursor control device is a mouse.

17. The method of claim 11, wherein the cursor control device is a touchpad.
